(19) United States
(12) Patent Application Publication
(10) Pub. No.: US 2017/0199888 A1
(43) Pub. Date: Jul. 13, 2017

(54) DETECTING VISIBILITY OF A CONTENT ITEM IN A CONTENT ITEM SLOT ON A RESOURCE

(71) Applicant: Google Inc., Mountain View, CA (US)

(72) Inventors: Tuna Toksoz, Mountain View, CA (US); Thomas Price, San Francisco, CA (US)

(21) Appl. No.: 14/994,605

(22) Filed: Jan. 13, 2016

(51) Int. Cl. G06F 17/30; G06Q 30/02

(52) U.S. Cl. CPC G06F 17/3089; G06F 17/30601; G06Q 30/0273

(57) ABSTRACT

Systems and methods for detecting the visibility of a content item on a resource are provided. One method includes receiving coordinates of a content item slot on a resource. The method further includes splitting the content item slot into a plurality of slot pieces. The method further includes, for each slot piece, determining a representative point of the slot piece and determining whether the slot piece is an uppermost element of the resource visible to a viewer of the resource at the representative point. The method further includes calculating an amount of slot pieces determined to be the uppermost elements of the resource at the representative points. The method further includes detecting a visibility of the content item in the content item slot based at least in part on the amount of slot pieces determined to be the uppermost elements of the resource at the representative points.

### BACKGROUND

In a networked environment, such as the Internet, first-party content providers can provide information to user devices for public presentation on resources, such as webpages, mobile applications, documents, other applications, and/or other resources. Additional third-party content can also be provided by third-party content providers for presentation on the user devices together with the information from the first-party content providers. A publisher may provide first-party content and third-party content on his or her resource. One challenge publishers face is how the third-party content is displayed on the resource.

### SUMMARY

One illustrative implementation of the disclosure relates to a method. The method includes receiving, by one or more processors, coordinates of a content item slot on a resource, wherein the content item slot is configured to display a content item from a third-party content provider on a resource. The method further includes splitting, by the one or more processors, the content item slot into a plurality of slot pieces. The method further includes, for each slot piece, determining, by the one or more processors, a representative point of the slot piece. The method further includes, for each slot piece, determining, by the one or more processors, whether the slot piece is an uppermost element of the resource visible to a viewer of the resource at the representative point. The method further includes calculating, by the one or more processors, an amount of slot pieces determined to be the uppermost elements of the resource at the representative points. The method further includes detecting, by the one or more processors, a visibility of the content item in the content item slot based at least in part on the amount of slot pieces determined to be the uppermost elements of the resource at the representative points.

Another implementation relates to a system including at least one computing device operably coupled to at least one memory. The at least one computing device is configured to receive coordinates of a content item slot on a resource, wherein the content item slot is configured to display a content item from a third-party content provider on a resource. The at least one computing device is further configured to split the content item slot into a plurality of slot pieces. The at least one computing device is further configured to, for each slot piece, determine a representative point of the slot piece. The at least one computing device is further configured to, for each slot piece, determine whether the slot piece is an uppermost element of the resource visible to a viewer of the resource at the representative point. The at least one computing device is further configured to calculate an amount of slot pieces determined to be the uppermost elements of the resource at the representative points. The at least one computing device is further configured to detect a visibility of the content item in the content item slot based at least in part on the amount of slot pieces determined to be the uppermost elements of the resource at the representative points.

Yet another implementation relates to one or more computer-readable storage media having instructions stored thereon that, when executed by one or more processors, cause the one or more processors to execute operations. The operations include receiving coordinates of a content item slot on a resource, wherein the content item slot is configured to display a content item from a third-party content provider on a resource. The operations further include splitting the content item slot into a plurality of slot pieces. The operations further include, for each slot piece, determining a representative point of the slot piece and determining whether the slot piece is an uppermost element of the resource visible to a viewer of the resource at the representative point. The operations further include calculating an amount of slot pieces determined to be the uppermost elements of the resource at the representative points. The operations further include comparing the amount of slot pieces to a threshold number, wherein the threshold number relates to a minimum number of slot pieces for which the slot pieces should be the uppermost element at the representative points to determine that the content item is visible. The operations further include classifying the content item as visible if the amount of slot pieces is greater than or equal to the threshold and classifying the content item as not visible if the amount of slot pieces is less than the threshold.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a block diagram of a content visibility system and associated environment according to an illustrative implementation.

FIG. 2 is a detailed block diagram illustrating a process of interacting with a publisher of a webpage based on the visibility of content items on the webpage according to an illustrative implementation.

FIG. 3 is an example user interface including a content item slot, illustrating the process of determining the visibility of a content item, according to an illustrative implementation.

FIG. 4 is a flow diagram of a process for determine the visibility of a content item on a resource according to an illustrative implementation.

FIG. 5 is a block diagram of a computing system according to an illustrative implementation.

### DETAILED DESCRIPTION

Following below are more detailed descriptions of various concepts related to, and implementations of, methods, apparatuses, and systems for providing information using a computer network. The various concepts introduced above and discussed in greater detail below may be implemented in any of numerous ways as the described concepts are not limited to any particular manner of implementation. Examples of specific implementations and applications are provided primarily for illustrative purposes.

Referring generally to the figures, various illustrative systems and methods are provided for detecting the visibility of a content item on a resource (e.g., a webpage or mobile application). More specifically, the present disclosure related to determining if an object on the resource is at least partially obscuring a content item by being displayed on top of the content item.

A resource (e.g., a webpage or mobile application) may include one or more content item slots (e.g., a content interface, such as within an iframe) in which a content item may be inserted. The resource may generally include a plurality of elements (e.g., text, video, images, content item, etc.) to display on the resource. Each element may be displayed in a particular location on the resource. The positioning of each element may be defined by, for example, coordinates (e.g., three-dimensional x−y-z coordinates) defining the location of the element in the layout of the resource. The z-direction may indicate the positioning of elements on a resource that are stacked on top of one another. For example, for multiple elements sharing x−y coordinates, the z coordinate may define which elements are layered on top and which elements are layered on bottom. The elements on the bottom may or may not be wholly or partially visible, depending on each element displayed at the z-coordinate.

Viewability detection code may generally be used to determine if a content item is being displayed properly on a resource. The code may work with the position of the content item within the given resource, the scroll status, the size of the viewport, and other such information. However, the code has no emphasis of the order of elements of the resource in the z-direction. Therefore, it may be possible to circumvent the viewability detection code by displaying an element on top of the content item. This may cause an impression to be counted for the content item on the resource when in fact the content item was not visible. In some implementations, a publisher of the resource may be paid by a content management system for displaying a content item on a resource (e.g., being paid for each impression of the content item). However, the publisher may be paid for a content item impression even if the content item is being obscured on the resource by another element sharing the same z-coordinate as the content item.

Referring to the present disclosure, to determine the visibility of a content item in the content item slot, a method may be executed for a resource (e.g., by code embedded within the code of the resource and/or code operating within an iframe). The method includes retrieving coordinates of the content item slot. The content item slot may then be split into a number of slot pieces. In one implementation, the content item slot is split into a total of M*N rectangular pieces (M points in width, N points in height). In other implementations, the content item slot is split into any number of equal or non-equal slot pieces, in any shape.

The method further includes determining a representative point for each slot piece. In one implementation, the representative point is a center point of the slot piece. For each representative point, the top element at the representative point on the resource is retrieved from the resource. The top element is the element visible on the resource at the selected point when the resource is loaded (i.e., the element with a z-coordinate causing the element to be displayed over all other elements at the point). The top element may be, for example, the content item or another object on the resource (e.g., text, an image, a video, or other first-party content). Code may be used to retrieve the top element. For example, the JavaScript method elementFromPoint may be invoked to cause the top element at the representative point to be retrieved.

A visibility of a content item in the content item slot is calculated based on the top element visible at each representative point. For example, if there are a total of M*N rectangular slot pieces, the visibility may be calculated as a percentage or ratio (the number of rectangular pieces for which the content item is visible, divided by the total number of rectangular pieces). As another example, the visibility may be represented as a raw number or using a simple yes/no determination (e.g., if the visibility is greater than a threshold percentage or ratio). An alternative implementation of the method may include determining a portion of the content item or content item slot that is currently visible on a resource (e.g., a portion of the content item slot may be cut off depending on the scroll status of the browser displaying the resource), dividing the visible portion into slot portions, and determining visibility within the portion.

The calculated visibility can then be used to provide assistance to resource publishers. For example, a resource may block a content item from display in a consistent manner (e.g., always displaying an object over the content interface). The visibility method can detect the visibility of content items in the content interface over time and determine that the content item is blocked consistently. Suggestions may be provided to the publishers to prevent the blocking of the content item in the future.

The method may further be used to adjust how much a publisher is paid for display of the content item (e.g., if the content item is not displayed properly, the publisher may not be paid for the display of the content item, or may be paid a reduced rate). Further, a bid (or any other parameter related to the process of selecting and displaying content items) of the content provider for publishing the content item within the resource of the publisher may be adjusted based on a visibility that the content item may have on the resource of the publisher.

The method can further determine why a content item is not visible based on website or browser settings, in some implementations. For example, the content item may not be visible because it is displayed on a webpage or browser that does not support a format of the content item. In some implementations, the method can be used to detect fraud (e.g., determine if the publisher is intentionally blocking the content item from being displayed properly).

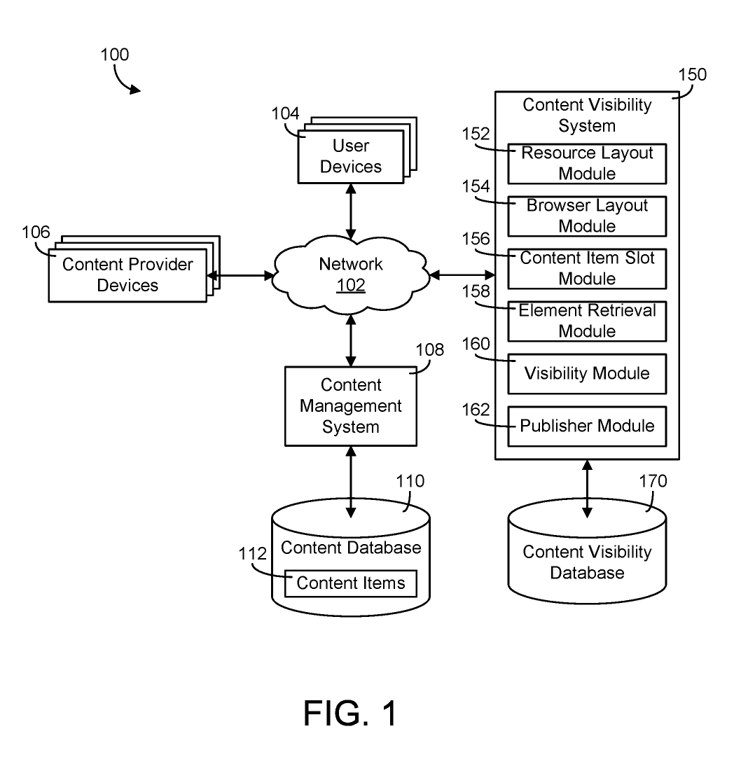

Referring now to FIG. 1, and in brief overview, a block diagram of a content visibility system 150 and associated environment 100 is shown according to an illustrative implementation. One or more user devices 104 may be used by a user to perform various actions and/or access various types of content, some of which may be provided over a network 102 (e.g., the Internet, LAN, WAN, etc.). For example, user devices 104 may be used to access webpages (e.g., using an Internet browser), media files, and/or any other types of content. A content management system 108 may be configured to select content for display to users within resources (e.g., webpages, applications, etc.) and to provide content items 112 from a content database 110 to user devices 104 over network 102 for display within the resources. The content items from which content management system 108 selects may be provided by one or more content providers via network 102 using one or more content provider devices 106. In some implementations, bids for content to be selected by content management system 108 may be provided to content management system 108 from content providers participating in an auction. In such implementations, content management system 108 may determine content to be published in one or more content interfaces of resources (e.g., webpages, applications, etc.) shown on user devices 104 based at least in part on the bids.

A content visibility system 150 may be configured to receive resource information for a resource being displayed on a user device 104. The resource information may be used to determine the visibility of one or more content items on the resource. In one implementation, user device 104 may belong to a publisher of the resource, and content visibility system 150 may determine for the publisher if content items are properly displayed on the resource. In another implementation, user device 104 may belong to a visitor of the resource, and content visibility system 150 may determine if content items are visible to the visitor. In some implementations, content visibility system 150 may retrieve and analyze resource visibility information for a third-party content provider publishing content on a resource. Content visibility system 150 may further manage one or more interactions with the publisher based on the visibility of content items. For example, content visibility system 150 may work in conjunction with content management system 108 to adjust how much a publisher is compensated for the display of a content item, to adjust a content auction among third-party content providers to account for the visibility of content items in the content item slot to which the auction is directed, and the like.

Referring in greater detail to FIG. 1, user devices 104 and/or content provider devices 106 may be any type of computing device (e.g., having a processor and memory or other type of computer-readable storage medium), such as a television and/or set-top box, mobile communication device (e.g., cellular telephone, smartphone, etc.), computer and/or media device (desktop computer, laptop or notebook computer, netbook computer, tablet device, gaming system, etc.), or any other type of computing device. In some implementations, one or more user devices 104 may be set-top boxes or other devices for use with a television set. In some implementations, content may be provided via a web-based application and/or an application resident on a user device 104. In some implementations, user devices 104 and/or content provider devices 106 may be designed to use various types of software and/or operating systems. In various illustrative implementations, user devices 104 and/or content provider devices 106 may be equipped with and/or associated with one or more user input devices (e.g., keyboard, mouse, remote control, touchscreen, etc.) and/or one or more display devices (e.g., television, monitor, CRT, plasma, LCD, LED, touchscreen, etc.). As described in the present disclosure, user devices 104 may be accessible by either a visitor of a resource or by a publisher of a resource.

User devices 104 and/or content provider devices 106 may be configured to receive data from various sources using a network 102. In some implementations, network 102 may include a computing network (e.g., LAN, WAN, Internet, etc.) to which user devices 104 and/or content provider device 106 may be connected via any type of network connection (e.g., wired, such as Ethernet, phone line, power line, etc., or wireless, such as WiFi, WiMAX, 3G, 4G, satellite, etc.). In some implementations, network 102 may include a media distribution network, such as cable (e.g., coaxial metal cable), satellite, fiber optic, etc., configured to distribute media programming and/or data content.

Content management system 108 may be configured to conduct a content auction among third-party content providers to determine which third-party content is to be provided to a user device 104. For example, content management system 108 may conduct a real-time content auction in response to a user device 104 requesting first-party content from a content source (e.g., a webpage, search engine provider, etc.) or executing a first-party application. Content management system 108 may use any number of factors to determine the winner of the auction. For example, the winner of a content auction may be based in part on the third-party content provider's bid and/or a quality score for the third-party provider's content (e.g., a measure of how likely the user of the user device 104 is to click on the content). In other words, the highest bidder is not necessarily the winner of a content auction conducted by content management system 108, in some implementations.

Content management system 108 may be configured to allow third-party content providers to create campaigns to control how and when the provider participates in content auctions. A campaign may include any number of bid-related parameters, such as a minimum bid amount, a maximum bid amount, a target bid amount, or one or more budget amounts (e.g., a daily budget, a weekly budget, a total budget, etc.). In some cases, a bid amount may correspond to the amount the third-party provider is willing to pay in exchange for their content being presented at user devices 104. In some implementations, the bid amount may be on a cost per impression or cost per thousand impressions (CPM) basis. In further implementations, a bid amount may correspond to a specified action being performed in response to the third-party content being presented at a user device 104. For example, a bid amount may be a monetary amount that the third-party content provider is willing to pay, should their content be clicked on at the client device, thereby redirecting the client device to the provider's resource. In other words, a bid amount may be a cost per click (CPC) bid amount. In another example, the bid amount may correspond to an action being performed on the third-party provider's resource, such as the user of the user device 104 making a purchase. Such bids are typically referred to as being on a cost per acquisition (CPA) or cost per conversion basis.

A campaign created via content management system 108 may also include selection parameters that control when a bid is placed on behalf of a third-party content provider in a content auction. If the third-party content is to be presented in conjunction with search results from a search engine, for example, the selection parameters may include one or more sets of search keywords. For instance, the third-party content provider may only participate in content auctions in which a search query for “golf resorts in California” is sent to a search engine. Other illustrative parameters that control when a bid is placed on behalf of a third-party content provider may include, but are not limited to, a topic identified using a device identifier's history data (e.g., based on resources visited by the device identifier), the topic of a resource or other first-party content with which the third-party content is to be presented, a geographic location of the client device that will be presenting the content, or a geographic location specified as part of a search query. In some cases, a selection parameter may designate a specific resource or resources with which the third-party content is to be presented. For example, an advertiser selling golf equipment may specify that they wish to place an advertisement on the sports page of a particular online newspaper.

In some implementations, a publisher may access his or her resource on a user device 104. One or more content items, selected by content management system 108 as described above, may be provided for display on the resource. Using user device 104, a publisher may configure his or her resource to display the one or more content items on the resource. In various implementations, the publisher may designate one or more content item slots on the resource in which content items may be displayed. The publisher may further designate any restrictions on the types of content items that can be provided in the content item slot (e.g., allowing images or video, restricting the content item to just text, restricting the format of an image or video, restricting the subject or topic of the content item, restricting the size of the content item, etc.). The publisher may designate when or if content items are to be displayed in the content item slot (e.g., based on the type of user browsing the resource, based on the type of user device accessing the resource, only displaying a particular content item at a time of day or day of week, etc.). The publisher may customize the appearance of the content item in any way by adjusting one or more properties of the content item slot on the resource. The publisher may further customize any element to be displayed on the resource as is commonly known in the art.

As described above, a content visibility system 150 is configured to determine a visibility of a content item in a content item slot on a resource. In one implementation, a publisher may provide an input to content visibility system 150 to cause the system to determine the visibility of a content item. In another implementation, content visibility system 150 may determine the visibility of a content item in a loaded resource based on the resource being loaded on a user device of a visitor of the resource. Content visibility system 150 may retrieve webpage or browser information from a user device 104 in such an implementation. Content visibility system 150 may determine the visibility of a content item with or without the input of a publisher of the resource on which the content item is displayed.

Content visibility system 150 may include one or more processors (e.g., any general purpose or special purpose processor), and may include and/or be operably coupled to one or more memories (e.g., any computer-readable storage media, such as a magnetic storage, optical storage, flash storage, RAM, etc.). In various implementations, content visibility system 150 may be implemented as a separate system or may be integrated with another system within environment 100 (e.g., content management system 108).

Content visibility system 150 may include one or more modules (e.g., implemented as computer-readable instructions executable by a processor) configured to perform various functions of content visibility system 150. Content visibility system 150 includes a resource layout module 152 and a browser layout module 154. Resource layout module 152 may be configured to determine a layout of a resource. The layout of the resource may generally include, for example, various elements or objects displayed on the resource, including coordinates for each element or object on the resource. The layout of the various elements and objects on the resource may be used to assist in determining a visibility of a content item on the resource as described below. Resource layout module 152 may identify one or more content item slots on the resource for which the visibility determination methods of the present disclosure should be executed. Content visibility system 150 may determine the visibility of all content items displayed on a resource, or may be configured (based on a determination or on publisher input) to only determine the visibility of a subset of or only one of the content items.

Browser layout module 154 may be configured to determine one or more browser properties (or properties of another application configured to display the resource) that may affect the display of elements and objects on a webpage (or other resource). For example, a browser may not support a particular media type, may include an add-on that blocks certain types of content from displaying on the resource, and the like.

Content visibility system 150 includes a content item slot module 156. Content item slot module 156 is configured to determine one or more properties of a content item slot on a resource. The properties are then used to determine if the content item displayed in the content item slot is visible. The content item slot properties may include the coordinates of the content item slot (or other information indicating the location of the content item slot on the resource). In some implementations, the location of the content item slot may be indicated using x−y coordinates. For example, if the content item slot is rectangular in shape, the position of the content item slot is indicated by four values (x1, y1, x2, y2) indicating a boundary of the content item slot. The width (x2−x1) and height (y2−y1) of the content item slot may also be determined by content item slot module 156. In other implementations, the content item slot may be any size or shape (e.g., oval, circular, triangular, or any other type of shape). Content item slot module 156 may be configured to determine one or more endpoints, corners, lines, or shapes defining the boundary and location of the content item slot.

Content item slot module 156 may further split the content item slot into multiple slot pieces. Each slot piece may then be tested by content visibility system 150 as described below. In some implementations, each slot piece may be the same size. For example, if the content item is rectangular in shape, the content item slot may be split into a plurality of smaller rectangles. The content item slot may be split into M×N rectangular slot pieces, where the width of each slot piece is defined as pw=width/M and the length of each slot piece is defined as ph=height/N. In other implementations, the content item slot may be split into a plurality of unequal slot pieces (e.g., each slot piece may be a different size) based on various properties of the content item slot (e.g., a type or format of content item to be displayed in the content item slot). In yet other implementations, the content item slot may be of any shape or size, and the content item slot may be split into any number of slot pieces, wherein the slot pieces may be either equal in size to one another or not. In other words, the values M and N may vary (e.g., based on the size of the content item slot, based on a minimum size required for each slot piece, etc.) and the values pw and ph may either vary or be equal across each slot piece.

Content item slot module 156 may further identify, for each slot piece, a representative point of the slot piece. For example, if each slot piece is a rectangular slot piece, the representative point of the slot piece may be identified as the center point of the slot piece. The center point is mathematically represented as ((x1+(i*pw)+pw/2), (y1+j*ph)+ph/2)), where (i, j) is the index of the slot piece. As another example, for a slot piece of any size or shape, a center point of the slot piece may be identified as the representative point. As yet another example, the representative point may be any point within or on the boundary of the slot piece, and may be chosen based on various display properties of the slot piece (i.e., the representative point may be a point on the boundary of the slot piece, in order to determine if a content item is fully visible within the slot piece). In some implementations, multiple representative points may be chosen for a slot piece.

Content visibility system 150 includes an element retrieval module 158. Element retrieval module 158 is configured to retrieve, for a given set of coordinates, an element from a resource for each set of coordinates. In some implementations, there may be multiple elements on the resource at a single set of coordinates (e.g., a single x−y point). Element retrieval module 158 may be configured to only retrieve the uppermost element at the single set of coordinates. When multiple elements are present at a single set of coordinates, element retrieval module 158 may compare the z-coordinate of each element to determine which element is the uppermost element. The uppermost element is the visible element (or the most visible among all elements, in some cases) on the resource at the single set of coordinates.

The set of coordinates from which element retrieval module 158 retrieves elements are the representative points of each slot piece of a content item slot. Therefore, one of the elements at each of the representative points is the slot piece which includes the representative point. Element retrieval module 158 therefore retrieves the slot piece as the element at each representative point if the slot piece is the top-most element (and retrieves an element different from the content item otherwise).

Element retrieval module 158 may retrieve the uppermost element at each set of coordinates based on any type of method or code. For example, element retrieval module 158 may invoke the JavaScript method elementFromPoint to retrieve the uppermost element at each set of coordinates. The elementFromPoint method (or another method or code configured to retrieve the uppermost element) may receive a set of coordinates as the input (e.g., a horizontal position x and a vertical position y within the current viewport displayed on the browser). The elementFromPoint method determines all elements at the set of coordinates and compares the z-coordinate for each element. The element with the highest z-coordinate is determined to be the uppermost element at the set of coordinates.

Content visibility system 150 includes a visibility module 160. Visibility module 160 is configured to determine a visibility of a content item in a content item slot based on the elements retrieved by element retrieval module 158. In other words, visibility module 160 may determine the visibility of a content item based on a z-coordinate of the content item. In some implementations, visibility module 160 may calculate a percentage or ratio indicating how much of the content item is visible. For example, visibility module 160 may count the total number of slot pieces (e.g., M×N total slot pieces for a rectangular content item slot) and the total number of times (“counter”) a slot piece was retrieved by element retrieval module 158. The visibility of the content item may then be calculated as “counter”/M×N. In other implementations, visibility module 160 may calculate the percentage (or ratio), and determine if the percentage exceeds a visibility threshold (e.g., if the percentage exceeds the threshold, visibility module 160 may determine that the content item is visible enough for the resource). In various other embodiments, visibility module 160 may adjust such calculations to account for various properties relating to the content item. For example, if one portion of the content item is more important compared to another portion, if there is a link or other object that a user viewing the resource can interact with, etc., the calculation may be adjusted.

Visibility module 160 may further determine the visibility of a content item based on the other coordinates (e.g., x−y coordinates) of the content item instead of or in addition to the z-coordinate of the content item. In various implementations, visibility module 160 may combine visibility detection features described herein with other visibility detection features that account for determining a visibility of a content item on the x−y coordinates of the content item. A method for determining the visibility of a content item in a content item slot (in the x−y coordinates) may generally include determining if the content item is within the viewport of the webpage. The viewport includes a portion of the webpage that is currently displayed in the browser or application. For example, for a webpage and browser, the viewport may vary based on the defined width and height of the webpage and browser, a default window size, one or more user settings or user interactions, and the like. For example, a user may manually change the dimensions of the browser, the user may scroll up or down the webpage, the webpage may be configured to fit all content on the webpage within the viewport no matter the size of the browser, etc. The viewport may be defined via x−y coordinates, which may be compared to the coordinates of the content item slot to determine if the content item is visible (or at least partially visible). The visibility may be represented as a percentage, in some implementations.

In some implementations, logic may be implemented within the browser or application to determine whether a content item is currently visible in the viewport of the resource. The logic may trigger events to notify content visibility system 150 if the content item is viewable. In other implementations, visibility module 160 may determine whether the content item is visible. It should be understood that the determination of whether a content item is visible in the x−y coordinate may vary according to various methods, and may be determined either before or concurrently with determining whether a content item is visible in the z-coordinate.

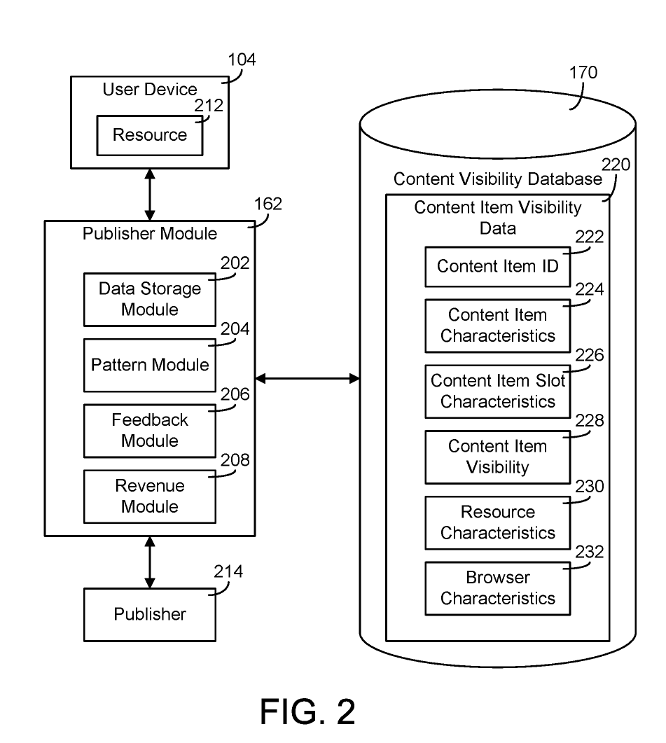

Content visibility system 150 includes a publisher module 162. Based on the determination made by visibility module 160, publisher module 162 may be configured to generate one or more recommendations to a publisher regarding the visibility of a content item. For example, if a content item is not visible on the resource, it may not be possible for a viewer of the resource to interact with the content item (e.g., to cause an impression, conversion, or other interaction with the content item). Since the publisher is typically compensated for providing the content item on the resource (e.g., the publisher receives compensation for an impression or conversion associated with the content item), it is important that a content item provided for display on the resource is actually visible to a viewer of the resource. Otherwise, the publisher may be credited with a content item impression that did not actually happen (and therefore may receive compensation for displaying a content item when the content item was not actually visible). Publisher module 162 may generally be configured to manage interaction with a publisher when such a situation happens. Publisher module 162 is described in greater detail in FIG. 2.

Environment 100 is shown to include a content visibility database 170 configured to store visibility information for a plurality of content items and content item slots. Content visibility database 170 may allow publisher module 162 to track the visibility of content items and content item slots over time for a given resource or a given set of resources for a publisher. Using data stored in content visibility database 170, publisher module 162 may determine one or more trends relating to the visibility of content items on a resource over time. Content visibility database 170 is described in greater detail in FIG. 2. It should be understood that content visibility database 170 may store visibility data in any format within the database and may be any type of data storage device.

Referring now to FIG. 2, the activities of publisher module 162 and content visibility database 170 are shown in greater detail. Publisher module 162 may be configured to interact with a publisher 214 based on the visibility of one or more content items on a resource of the publisher. Publisher module 162 may generally use the visibility of a content item on a resource to generate one or more recommendations for the publisher and to store content item visibility information in content visibility database 170.

In some implementations, publisher module 162 may notify a publisher 214 if content visibility system 150 determines a content item in a content item slot is not visible on a resource 212. In other implementations, publisher module 162 may, in response to the determination that a content item in a content item slot is not visible on resource 212, store an indication in content visibility database 170. Publisher module 162 may then determine if there is a repeated pattern of content items not being visible on resource 212. In other words, publisher module 162 may either notify a publisher 214 if a single content item is not visible or only if multiple content items over time are not visible on the publisher's resource 212.

Publisher module 162 includes a data storage module 202 configured to store content item visibility data 220 in content visibility database 170. Content item visibility data 220 may generally relate to data regarding the visibility of a content item on a resource 212 being displayed on a user device 104. Content item visibility data 220 may be generated for each content item and content item slot for which content visibility system 150 tests, or may be generated only for content items that are determined not to be visible. Content item visibility data 220 may include a content item identifier 222 identifying the content item not being displayed properly on the resource, content item characteristics 224 (e.g., a media file type, a subject of the content item, etc.), content item slot characteristics 226 (e.g., the location or coordinates of the content item slot on the resource), content item visibility 228 (e.g., if the content item is completely blocked or partially blocked by other elements on the resource), resource characteristics 230 (e.g., other elements displayed on the resource, general resource settings that impact the display of elements), and browser characteristics 232 (e.g., the type of browser or other application used to load the resource).

Publisher module 162 includes a pattern module 204. As described above, publisher module 162 may determine, over time, if a content item is consistently blocked from being displayed properly on a webpage by other elements on the resource. Pattern module 204 may review all content item visibility data 220 relating to a single resource or a single publisher (or a specific subset of resources or content item slots within a resource) and determine if the content items are being blocked from displaying properly on a consistent basis and/or in a consistent manner. As one example, content item identifiers 222 may be reviewed to determine if a type of content item is consistently blocked (e.g., all content items from a particular third-party content provider are not being displayed properly). As another example, content item characteristics 224 may be reviewed to determine if a type of content item is consistently blocked (e.g., all video content items not playing back properly, all text-based content items being cut off in a certain way, etc.). As yet another example, content item slot characteristics 226 may be reviewed to determine if a content item slot placed in a certain location is always blocked by other elements on the resource (e.g., a content item slot at the top of the page is always 50% blocked by other elements). As another example, pattern module 204 may review content item visibility 228 for a plurality of content items to determine if the content item is being blocked in a consistent way (e.g., the content item is always 80% blocked regardless of the placement of the content item slot). As yet another example, pattern module 204 may review resource characteristics 230 and browser characteristics 232 and determine that one or more resource or browser settings are causing the content item not to display properly.

Pattern module 204 may determine if a content item is being prevented from displaying properly in a consistent manner. In some implementations, pattern module 204 may be able to determine that a resource (and more particularly the publisher of the resource) is preventing the content item from being visible in a consistent manner (e.g., always displaying certain elements over the content item slot). This may allow pattern module 204 to determine that the publisher is either blocking the content item on purpose or if the resource, browser, or application has one or more settings that causes the content item to be blocked consistently.

Publisher module 162 includes a feedback module 206 configured to generate feedback for a publisher 214 relating to the visibility of content items. Publisher module 162 may be configured to notify publisher 214 if a plurality of content items are not displaying properly or if a single content item is not displaying properly. In some implementations, feedback module 206 may not generate a report unless content items are being blocked in a consistent manner. In some implementations, feedback module 206 may generate a report periodically for the publisher. It should be understood that publisher module 162 may use any threshold to determine when to generate feedback for publisher 214 (e.g., when a threshold number of content items over time are not displayed properly, when a threshold number of content items are determined to have less than a threshold visibility percentage, etc.).

Publisher module 162 includes a revenue module 208 configured to manage payment to publisher 214 for displaying the content items. As generally described above, publisher 214 may be compensated for display of third-party content items on the publisher's website. In some implementations, revenue module 208 may use content item visibility data 220 to determine if (and how much) publisher 214 should be compensated for displaying the content items. For example, if content items are consistently partially blocked by other elements on the resource, a portion or all of the payment to publisher 214 may be withheld. As another example, if a threshold number of non-visible content items is not met, publisher 214 may not be fully compensated. Revenue module 208 may generally ensure that publisher 214 is fairly compensated for content item impressions that occur.

It should be understood that while various modules are shown in content visibility system 150 and publisher module 162, some or all of the activities therein may be executed by, for example, a content management system 208. In some embodiments, some or all of the activity may of publisher module 162 may be executed at content management system 208, allowing content management system 208 to adjust a content item auction or a third-party content provider campaign. Further, content management system 208 may manage one or more payments to publishers regarding content item impressions or conversions.

While user device 104 and publisher 214 are shown separate in FIG. 2, in various implementations, publisher 214 may use user device 104. As described above, in some embodiments, publisher 214 may use user device 104 and cause content visibility system 150 to determine if a content item on resource 212 is visible. In other embodiments, content visibility system 150 determines if a content item on resource 212 is visible without input from publisher 214 (e.g., determines if a content item is visible when a visitor of resource 212 loads the resource).

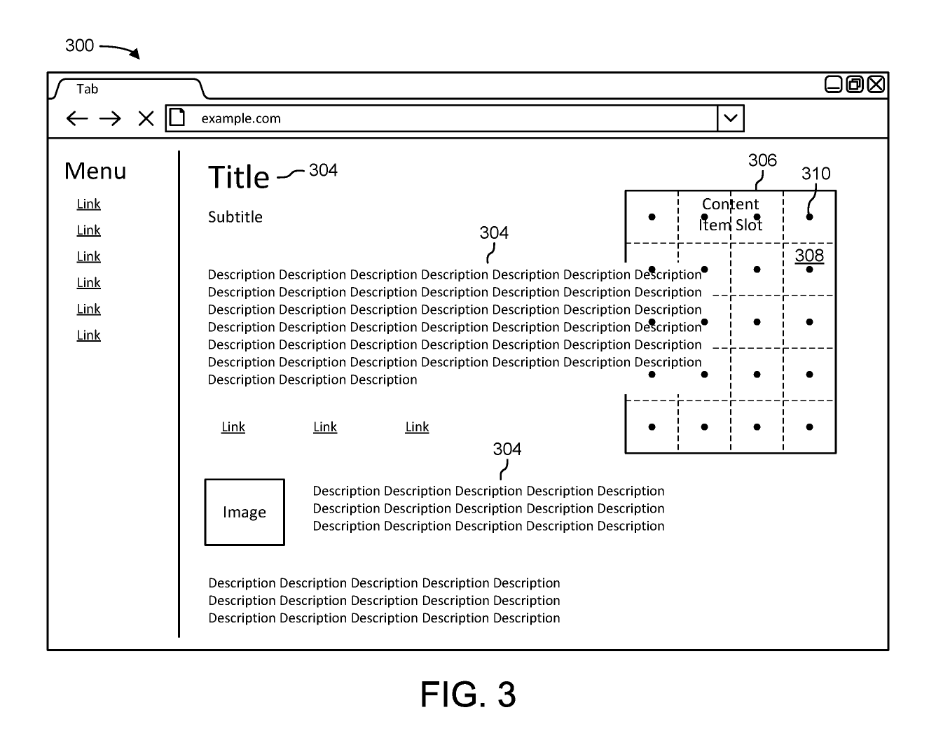

FIG. 3 is an example user interface 300 including a content item slot, illustrating the process of determining the visibility of a content item, according to an illustrative implementation. User interface 300 generally includes a webpage 302 including various elements 304 and a content item slot 306. Of course, webpage 302 may include any number of different elements 304 and content item slots 306; the user interface 300 as shown in FIG. 3 is provided by way of example only. Further, while webpage 302 is provided as an example resource in FIG. 3, in other implementations the resource may be a mobile application.

When detecting the visibility of a content item in content item slot 306, the content item slot may be split into multiple slot pieces 308. In the implementation of FIG. 3, each slot piece 308 is shown to be a rectangular slot piece equal in size. In other implementations, each slot piece may have a different size or shape, or each slot piece may be equal in size but a different shape. A total of twenty slot pieces 308 are shown created in content item slot 306. In various embodiments, any number of slot pieces may be created. The number of slot pieces may be based on the size of content item slot 306 (e.g., each slot piece may be required to be a minimum size, and as many slot pieces as possible may be created based on the minimum size). The number of slot pieces may also be a set number of slot pieces (e.g., always splitting content item slot 306 into twenty slot pieces). The number of slot pieces may further be set based on a shape of content item slot 306, and may be adjusted to account for any type of content item to be displayed in the slot (e.g., if a link is included in the content item, a slot piece may be created to account specifically for the link).

For each slot piece 308, a representative point 310 is determined. In some implementations, if each slot piece 308 is rectangular, the representative point 310 of each slot piece may be the center point, as illustrated in FIG. 3.

As shown in FIG. 3, an element 304 is shown overlapping with content item slot 306. The text associated with an element 304 is shown partially obscuring content item slot 306 and therefore a content item being displayed in the content item slot. As described above, element retrieval module 158 is configured to retrieve the uppermost element at each representative point 310. Therefore, in the implementation of FIG. 3, element retrieval module 158 retrieves content item slot 306 at fourteen of the representative points while retrieving element 304 at six of the representative points. Content visibility system 150 may then calculate the visibility of the content item in content item slot 306 at 70%. Content visibility system 150 may represent the visibility of the content item as the percentage, or may make a yes/no determination based on a threshold percentage (e.g., the content item is not visible if the threshold is 80%, the content item is visible if the threshold is 50%, etc.).

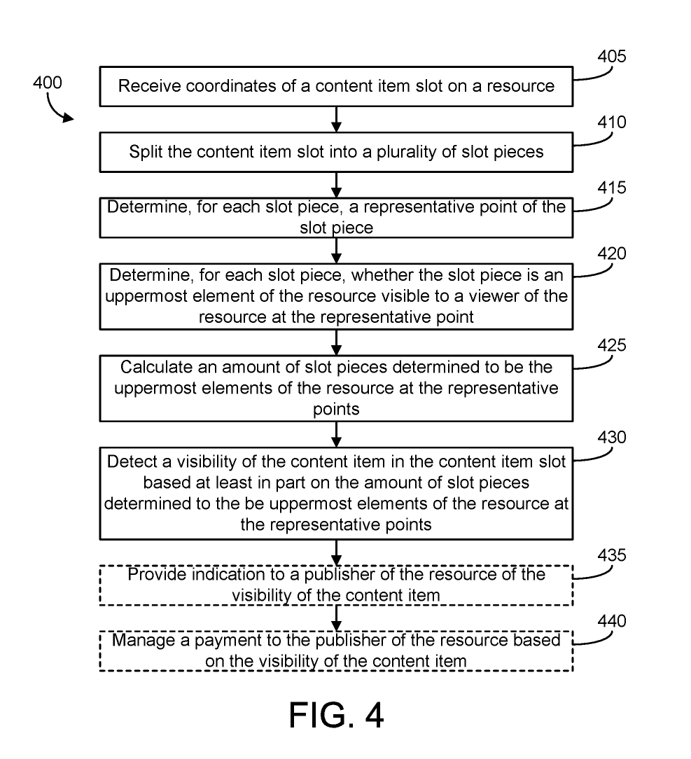

Referring now to FIG. 4, a flow diagram of a process 400 for determining the visibility of a content item on a resource is shown according to an illustrative implementation. Process 400 may be executed by, for example, content visibility system 150 as described with reference to FIG. 1-2. In various implementations, process 400 may be executed based on an input from a publisher (e.g., a publisher wants to find out if a content item is properly displayed on the publisher's resource) or based on an input from a user device of a visitor of a resource (e.g., when the resource is loaded for the visitor on the user device).

Process 400 includes receiving coordinates of a content item slot on a resource (405). The content item slot may be configured to display a content item from a third-party content provider on the resource. The content item may be any type of object or combination of objects (e.g., image, video, text, links, etc.) and may be chosen by a content management system or other system configured to provide third-party content for display on the resource. The coordinates may be, for example, x−y coordinates that identify the position of the content item slot on the resource in addition to the length, width, and other dimensions of the content item slot.

Process 400 further includes splitting the content item slot into a plurality of slot pieces (410). In some embodiments, each slot piece may be the same size. For example, if the content item slot is rectangular, each slot piece may be an equally sized rectangular piece. The size and shape of each slot piece may vary based on the size and shape of the content item slot, the type of content item displayable in the content item slot, resource or browser characteristics, and the like.

Process 400 further includes, for each slot piece, determining a representative point of the slot piece (415). In some embodiments, the representative point may be a center point of the slot piece. For example, for a rectangular slot piece, the representative point is a center point of the rectangle. In other embodiments, the representative point may be another point within or on a boundary of the slot piece, and may be chosen based on the size and shape of the slot piece, the type of content item displayable in the slot piece, resource or browser characteristics, and the like.

Process 400 further includes, for each slot piece, determining whether the slot piece is an uppermost element of the resource visible to a viewer of the resource at the representative point (420). Block 420 may include, for example, retrieving the uppermost element at the representative point for each slot piece and determining if the uppermost element is the slot piece. In some implementations, a JavaScript method such as elementFromPoint may be invoked to retrieve the uppermost element at each representative point.

Process 400 further includes calculating an amount of slot pieces determined to be the uppermost elements of the resource at the representative points (425). Process 400 further includes detecting a visibility of the content item in the content item slot based at least in part on the amount of slot pieces determined to be the uppermost elements of the resource at the representative points (430). In some implementations, block 425 may include counting a total amount of slot pieces retrieved as the uppermost element at a representative point, and block 430 includes dividing the total by the total number of slot pieces and representing the visibility of the content item as a percentage or ratio. In some implementations, block 430 then further includes either representing the visibility as a percentage or determining that the content item is visible if the percentage is greater than a visibility threshold (e.g., 50%, 75%, 90%, etc.). Block 430 may further include determining a content item is visible or not visible based on which slot pieces were retrieved (e.g., if the slot pieces retrieved were clustered in one portion of the content item slot or not, if some slot pieces are more important for display than other slot pieces, etc.).

Process 400 may optionally include further blocks for providing indications to a publisher of the resource based on the visibility of a content item. Process 400 may include providing an indication to a publisher providing first-party content to the resource (435). The indication may include, if a percentage calculated at block 425 is less than a visibility threshold, a recommendation relating to the display of one or more content items or other elements on the resource. For example, the recommendation may include a location on the resource suitable for the content item and content item slot.

Process 400 may include managing a payment to the publisher of the resource for display of the content item (440). For example, if the content item is visible, a payment may be provided to a publisher for the impression of the content item. As another example, if the percentage calculated at block 425 is lower than the visibility threshold, a payment to the publisher may be withheld.

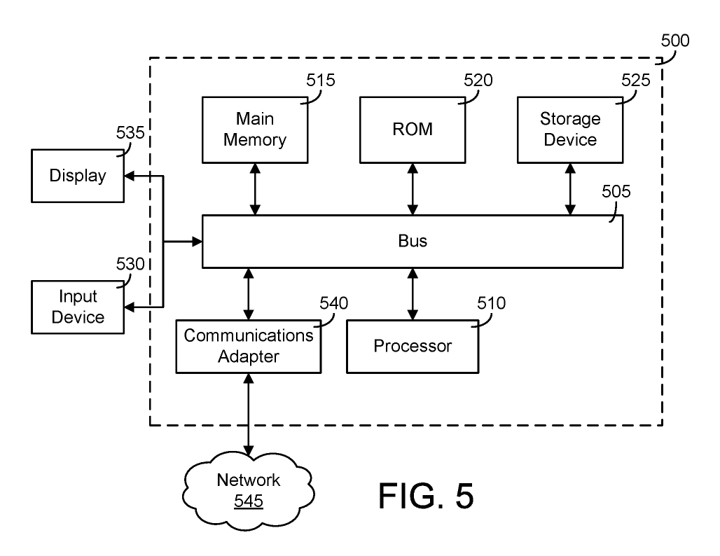

FIG. 5 illustrates a depiction of a computer system 500 that can be used, for example, to implement an illustrative user device 104, an illustrative content management system 108, an illustrative content provider device 106, an illustrative content visibility system 150, and/or various other illustrative systems described in the present disclosure. Computing system 500 includes a bus 505 or other communication component for communicating information and a processor 510 coupled to bus 505 for processing information. Computing system 500 also includes main memory 515, such as a random access memory (RAM) or other dynamic storage device, coupled to bus 505 for storing information, and instructions to be executed by processor 510. Main memory 515 can also be used for storing position information, temporary variables, or other intermediate information during execution of instructions by processor 510. Computing system 500 may further include a read only memory (ROM) 520 or other static storage device coupled to bus 505 for storing static information and instructions for processor 510. A storage device 525, such as a solid state device, magnetic disk or optical disk, is coupled to bus 505 for persistently storing information and instructions.

Computing system 500 may be coupled via bus 505 to a display 535, such as a liquid crystal display, or active matrix display, for displaying information to a user. An input device 530, such as a keyboard including alphanumeric and other keys, may be coupled to bus 505 for communicating information, and command selections to processor 510. In another implementation, input device 530 has a touch screen display 535. Input device 530 can include a cursor control, such as a mouse, a trackball, or cursor direction keys, for communicating direction information and command selections to processor 510 and for controlling cursor movement on display 535.

In some implementations, computing system 500 may include a communications adapter 540, such as a networking adapter. Communications adapter 540 may be coupled to bus 505 and may be configured to enable communications with a computing or communications network 545 and/or other computing systems. In various illustrative implementations, any type of networking configuration may be achieved using communications adapter 540, such as wired (e.g., via Ethernet®), wireless (e.g., via WiFi®, Bluetooth®, etc.), pre-configured, ad-hoc, LAN, WAN, etc.

According to various implementations, the processes that effectuate illustrative implementations that are described herein can be achieved by computing system 500 in response to processor 510 executing an arrangement of instructions contained in main memory 515. Such instructions can be read into main memory 515 from another computer-readable medium, such as storage device 525. Execution of the arrangement of instructions contained in main memory 515 causes computing system 500 to perform the illustrative processes described herein. One or more processors in a multi-processing arrangement may also be employed to execute the instructions contained in main memory 515. In alternative implementations, hard-wired circuitry may be used in place of or in combination with software instructions to implement illustrative implementations. Thus, implementations are not limited to any specific combination of hardware circuitry and software.

The systems and methods as described in the present disclosure may be implementable for any type of third-party content item (i.e., for any type of content item to be displayed on a resource). In one implementation, the content items may include advertisements. In one implementation, the content items may include any text, images, video, stories (e.g., news stories), social media content, links, or any other type of content provided by a third-party for display on the resource of a first-party content provider. The type of content item for which the content visibility methods herein are used for is not limiting.

Although an example processing system has been described in FIG. 5, implementations of the subject matter and the functional operations described in this specification can be carried out using other types of digital electronic circuitry, or in computer software, firmware, or hardware, including the structures disclosed in this specification and their structural equivalents, or in combinations of one or more of them.

Implementations of the subject matter and the operations described in this specification can be carried out using digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be implemented as operations performed by a data processing apparatus on data stored on one or more computer-readable storage devices or received from other sources.

The terms “data processing apparatus” or “computing device” encompass all kinds of apparatus, devices, and machines for processing data, including by way of example, a programmable processor, a computer, a system on a chip, or multiple ones, or combinations of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be carried out using a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be carried out using a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some illustrative implementations, the features disclosed herein may be implemented on a smart television module (or connected television module, hybrid television module, etc.), which may include a processing circuit configured to integrate Internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be carried out in combination or in a single implementation. Conversely, various features that are described in the context of a single implementation can also be carried out in multiple implementations, separately, or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination. Additionally, features described with respect to particular headings may be utilized with respect to and/or in combination with illustrative implementations described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products embodied on tangible media.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method comprising:
receiving, by one or more processors, coordinates of a content item slot on a resource, wherein the content item slot is configured to display a content item from a third-party content provider on the resource;
splitting, by the one or more processors, the content item slot into a plurality of slot pieces;
for each slot piece:
determining, by the one or more processors, a representative point of the slot piece, and
determining, by the or more processors, whether the slot piece is an uppermost element of the resource visible to a viewer of the resource at the representative point;
calculating, by the or more processors, an amount of slot pieces determined to be the uppermost elements of the resource at the representative points; and
detecting, by the or more processors, a visibility of the content item in the content item slot based at least in part on the amount of slot pieces determined to be the uppermost elements of the resource at the representative points.

2. The method of claim 1, wherein determining whether the slot piece is an uppermost element of the resource comprises calling a code portion configured to:
receive a first coordinate in a first dimension and a second coordinate in a second dimension, the first coordinate and second coordinate relating to a position in a viewport of the resource;
determine all elements located at the first coordinate and second coordinate;
compare a third coordinate in a third dimension of each element located at the first coordinate and second coordinate;
determine the uppermost element of all elements located at the first coordinate and second coordinate based on the comparison of the third coordinate of each element; and
determining if the uppermost element is the slot piece.

3. The method of claim 1, wherein detecting a visibility of the content item in the content item slot comprises:
dividing the number of slot pieces for which the slot piece is the uppermost element of the resource by the total number of slot pieces, and representing the visibility as a percentage.

4. The method of claim 3, further comprising determining that the content item is visible if the percentage is greater than a visibility threshold.

5. The method of claim 4, further comprising:
if the percentage is lower than the visibility threshold, providing an indication to a publisher providing first-party content to the resource, wherein the indication includes a recommendation relating to the display of one or more content items or other elements on the resource.

6. The method of claim 5, wherein the recommendation includes a location on the resource suitable for the content item and content item slot.

7. The method of claim 4, further comprising:
if the content item is visible, causing a payment to be provided to a publisher of the resource for display of the content item.

8. The method of claim 4, further comprising:
if the percentage is lower than the visibility threshold, causing a payment to be withheld to a publisher of the resource for display of the content item.

9. The method of claim 1, wherein the plurality of slot pieces are rectangular pieces.

10. The method of claim 9, wherein the representative point of each rectangular piece is a center point of the rectangular piece.

11. A system, comprising:
at least one computing device operably coupled to at least one memory and configured to:
receive coordinates of a content item slot on a resource, wherein the content item slot is configured to display a content item from a third-party content provider on the resource;
split the content item slot into a plurality of slot pieces;
for each slot piece:
determine a representative point of the slot piece, and
determine whether the slot piece is an uppermost element of the resource visible to a viewer of the resource at the representative point;
calculate an amount of slot pieces determined to be the uppermost elements of the resource at the representative points; and
detect a visibility of the content item in the content item slot based at least in part on the amount of slot pieces determined to be the uppermost elements of the resource at the representative points.

12. The system of claim 11, wherein determining whether the slot piece is an uppermost element of the resource comprises calling a code portion configured to:
receive a first coordinate in a first dimension and a second coordinate in a second dimension, the first coordinate and second coordinate relating to a position in a viewport of the resource;
determine all elements located at the first coordinate and second coordinate;
compare a third coordinate in a third dimension of each element located at the first coordinate and second coordinate;
determine the uppermost element of all elements located at the first coordinate and second coordinate based on the comparison of the third coordinate of each element; and
determining if the uppermost element is the slot piece.

13. The system of claim 11, wherein detecting a visibility of the content item in the content item slot comprises:
dividing the number of slot pieces for which the slot piece is the uppermost element of the resource by the total number of slot pieces, and representing the visibility as a percentage.

14. The system of claim 13, wherein the content item is determined to be visible if the percentage is greater than a visibility threshold.

15. The system of claim 14, further comprising:
if the percentage is lower than the visibility threshold, providing an indication to a publisher providing first-party content to the resource, wherein the indication includes a recommendation relating to the display of one or more content items or other elements on the resource.

16. The system of claim 15, wherein the recommendation includes a location on the resource suitable for the content item and content item slot.

17. The system of claim 14, wherein if the content item is visible, a payment is provided to a publisher of the resource for display of the content item.

18. The system of claim 14, wherein if the percentage is lower than the visibility threshold, a payment is withheld to a publisher of the resource for display of the content item.

19. The system of claim 11, wherein the plurality of slot pieces are rectangular pieces; and
wherein the representative point of each rectangular piece is a center point of the rectangular piece.

20. One or more computer-readable storage media having instructions stored thereon that, when executed by one or more processors, cause the one or more processors to execute operations comprising:
receiving coordinates of a content item slot on a resource, wherein the content item slot is configured to display a content item from a third-party content provider on the resource;
splitting the content item slot into a plurality of slot pieces;
for each slot piece:
determining a representative point of the slot piece, and
determining whether the slot piece is an uppermost element of the resource visible to a viewer of the resource at the representative point;
calculating an amount of slot pieces determined to be the uppermost elements of the resource at the representative points; and
comparing the amount of slot pieces to a threshold number, wherein the threshold number relates to a minimum number of slot pieces for which the slot pieces should be the uppermost element at the representative points to determine that the content item is visible;
classifying the content item as visible if the amount of slot pieces is greater than or equal to the threshold; and
classifying the content item as not visible if the amount of slot pieces is less than the threshold.
